(19) United States
(12) Patent Application Publication
(10) Pub. No.: US 2025/0021940 A1
(43) Pub. Date: Jan. 16, 2025

(54) SYSTEMS AND METHODS FOR INTERACTIVE REAL-TIME COLLABORATION, COMMUNICATION, AND VERIFICATION

(71) Applicant: Home52 LLC, Blue Ash, OH (US)

(72) Inventor: Suzanne A. Burke, Wyoming, OH (US)

(21) Appl. No.: 18/768,350

(22) Filed: Jul. 10, 2024

Related U.S. Application Data
(60) Provisional application No. 63/525,827, filed on Jul. 10, 2023.

(51) Int. Cl. G06Q 10/1093; G06Q 10/1091

(52) U.S. Cl. CPC G06Q 10/1095; G06Q 10/1091

(57) ABSTRACT

Certain aspects provide systems and methods including receiving profile information; generating one or more profiles based on the profile information; identifying one or more profile matches based on the one or more profiles; generating an appointment to perform one or more tasks based on the one or more profile matches; and recording a clock-in timestamp information and a clock-out timestamp information associated with the appointment to perform the one or more tasks, wherein the clock-in timestamp information and the clock-out timestamp information are verified against geolocation information of a device.

### CLAIM TO PRIORITY

This non-provisional patent application claims priority to and benefit of, under 35 U.S.C. § 119(e), U.S. Provisional Patent Application Ser. No. 63/525,827, filed Jul. 10, 2023 and titled “Systems And Methods For Interactive Real-Time Collaboration, Communication, And Verification”, all of which is incorporated by reference herein.

### TECHNICAL FIELD

The present specification relates to systems and methods for interactive real-time collaboration, communication, and verification.

### BACKGROUND

Caring for an aging loved one is difficult. There are many companies and programs that provide education, financial services, advocacy, etc. One example is Council on Aging of Southwestern Ohio's Elderly Services Program (ESP). The ESP helps older adults remain safe and independent in their homes. It expands care that may be provided by family and friends. ESP can delay or prevent nursing home placement. When ESP users elect to use consumer directed care (CDC) as a service, they are faced with significant paperwork that must be completed correctly in order to start their services. This process can be extensive should mistakes happen along the way. In addition, there are security concerns when operating in an electronic environment to process the service and, which if unaddressed, can lead to interception and misuse of data. These and other deficiencies exist.

### BRIEF SUMMARY

In one embodiment, a method is disclosed. The method includes receiving profile information. The method includes generating one or more profiles based on the profile information. The method includes identifying one or more profile matches based on the one or more profiles. The method includes generating an appointment to perform one or more tasks based on the one or more profile matches. The method includes recording a clock-in timestamp information and a clock-out timestamp information associated with the appointment to perform the one or more tasks, wherein the clock-in timestamp information and the clock-out timestamp information are verified against geolocation information of a device.

In another embodiment, an application system is disclosed. The application system includes one or more processors; and one or more memories. The one or more processors are configured to receive profile information. The one or more processors are configured to generate one or more profiles based on the profile information. The one or more processors are configured to identify one or more profile matches based on the one or more profiles. The one or more processors are configured to generate an appointment to perform one or more tasks based on the one or more profile matches. The one or more processors are configured to record a clock-in timestamp information and a clock-out timestamp information associated with the appointment to perform the one or more tasks, wherein the clock-in timestamp information and the clock-out timestamp information are verified against geolocation information of a device.

In another embodiment, a non-transitory computer-readable medium comprising instructions that, when executed by at least one processor, cause the at least one processor to perform operations is provided, the operations comprising: receiving profile information; generating one or more profiles based on the profile information; identifying one or more profile matches based on the one or more profiles; generating an appointment to perform one or more tasks based on the one or more profile matches; and recording a clock-in timestamp information and a clock-out timestamp information associated with the appointment to perform the one or more tasks, wherein the clock-in timestamp information and the clock-out timestamp information are verified against geolocation information of a device.

These and additional features provided by the embodiments described herein will be more fully understood in view of the following detailed description in conjunction with the drawings.

### DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 illustrates an example environment in which the systems and methods of the present disclosure may be used according to one or more embodiments shown and described herein.

FIG. 2 illustrates a method according to one or more embodiments shown and described herein.

FIG. 3 illustrates an entry system according to one or more embodiments shown and described herein.

FIG. 4 illustrates an example user interface according to one or more embodiments shown and described herein.

FIG. 5 illustrates an example user interface according to one or more embodiments shown and described herein.

FIG. 6 illustrates database schema according to one or more embodiments shown and described herein.

### DETAILED DESCRIPTION

Embodiments disclosed herein relate to systems and methods for interactive real-time collaboration, real-time communication, and real-time verification.

The systems and methods disclosed herein provide techniques that digitize the paperwork process to promote timely and error-free submissions while also improving user interactive experience within an application. In addition, the systems and methods disclosed herein also provide techniques for on-demand training, real-time and interactive communication, real-time verification, and real-time schedule coordination and collaboration within the application. Still further, the systems and methods disclosed herein provide techniques for real-time clocking in and clocking out for user customization of their own schedule and selectively identifying various type of care tasks they provide in accordance with their own schedule within the application. The systems and methods disclosed herein are implemented through an application that serves as a secure digital platform where individuals are matched with users to provide in-home care services based on customized profiles. Still further, using the systems and methods disclosed herein, the device running the application, may be equipped with a receiver configured for use with a Global Navigation Satellite System (GNSS) including, but not limited to, the Global Positioning System (GPS). From this receiver, location information of the device may be extracted and verified, in real-time, against the location of the device at the time of clock-in and clock-out information.

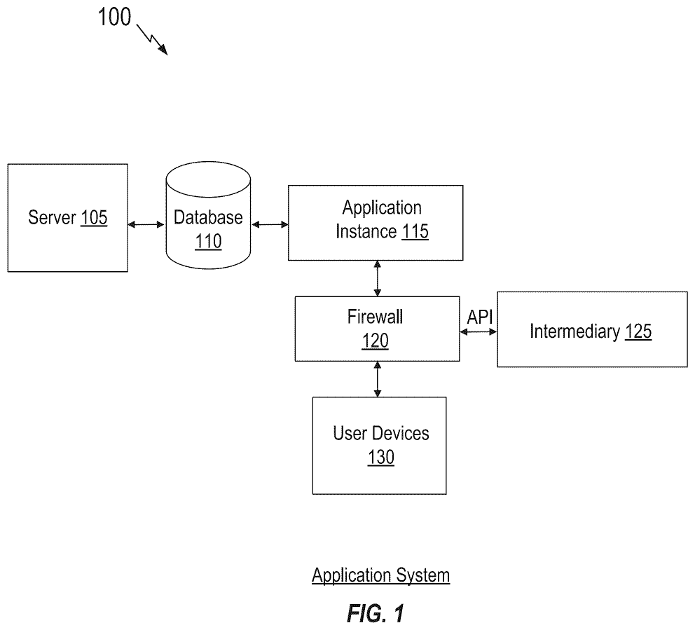

FIG. 1 illustrates an application system 100. The application system 100 includes a server 105, a database 110, an application instance 115, a firewall 120, an intermediary 125, and one or more user devices 130. The application system 100 may be deployed in the illustrated exemplary environment deployed according to one or more embodiments. Although single instances of the constituent components of application system 100 are depicted, any number of the constituent components of application system 100 may be included.

The server 105 may be connected to the database 110. In some examples, the server 105 may include an analytics module that is configured to exchange data with the database 110. Server 105 may be configured as a central system, server or platform to control and call various data at different times to execute a plurality of operations as disclosed herein. Without limitation, the server 105 may be configured to one or more requests for any operation from any constituent component of application system 100 and transmit a response that is responsive to the one or more requests for any operation. The database 110 may comprise a PostgreSQL database. The application instance 115 may run on an application server that is connected to the database 110. The application instance 115 may be packaged as a docker container image and deployed to Microsoft® Azure® cloud. In some examples, the terms “application instance” and “application” may be interchangeably used.

The firewall 120 may comprise an Azure® web application firewall (WAF). The firewall 120 may be configured for open web application security project (OWASP®) Top 10 mitigation. The OWASP® Top 10 is a standard awareness document for developers and web application security. It represents a broad consensus about the most critical security risks to web applications. The firewall 120 may be configured to protect applications and APIs from security attacks and exchange data with the intermediary 125 via an API. The firewall 120 may be configured to mitigate security vulnerabilities, such as broken object level authorization, broken authentication, broken object property level authorization, unrestricted resource consumption, broken function level authorization, unrestricted access to sensitive business flows, server side request forgery, security misconfiguration, improper inventory management, and unsafe consumption of APIs.

The intermediary 125 may comprise a fiscal intermediary processing system, as will be further explained below.

The one or more user devices 130 may comprise any number of devices that are configured to connect to a network, such as the Internet, and download and install an application, such as application 115, into its one or more non-transitory computer-readable mediums. The one or more user devices 130 may comprise at least one or more processors and at least one or more non-transitory computer-readable mediums (not shown) that stores the application 115. The one or more user devices 130 (e.g., a personal computer, a tablet computer, a cellular telephone, a smartphone or other smart device, a stateless device, or the like) may be used by a user to download and install the application 115. The at least one or more processors of the one or more user devices 130 may be configured to execute logic, and the at least one or more non-transitory computer-readable mediums may be configured to store information and/or computer readable instructions.

A plurality of users may be generated by the application 115. Without limitation, the plurality of users include a care manager, an employer, an observer, and an employee. Each user may be associated with one or more roles, and also associated with a predetermined permission level. It is understood that these users are not limited to these terms, and that other interchangeable terms may be used without departing from the scope of the disclosure. For example, and without limitation, the employer may also be referred to as a client or an employer user. The observer may also refer to an observer user. The employee may also be referred to as an application user or an aide or an aide user. An owner of the application 115 may be referred to as a case management company.

The care manager may be generated, for example by an admin, and may belong to an organization. An organization may have any number of clients and may be restricted to a particular location, for example, county or counties. The care manager manages the clients in the organization. As part of the client management in the organization, the care manager may be permitted to perform any of the following: create employers; create clients; view available employees; connect aides to employers; communicate with employers, observers, and employees; terminate employment relationships; deactivate service; pause service; create care plans, service lists, and budgets; view timesheets; and view past and upcoming appointments. The care manager may generate one or more employers. The employer may invite one or more observers and/or one or more employees.

The employer may be generated by the care manager. The employer manages the account or accounts of clients authorized for the CDC service by the care manager. Clients belonging to an organization manage the information that is entered to create clients under an employer account. Employers may be seeking an employee to complete pre-identified service needs of a client. Employers may also be referred to as a potential employer or a potential client. Employers may be permitted to perform any of the following: creation and editing of their profile; view available employees; initiate aide conversations; communication with observers, care managers, and employees' terminate employment relationships; request account deactivation; view contacted aides and aide profiles; send job offers; schedule appointments; view clock-in and clock-out timestamps in real-time; view geographic information relative to the timestamps; edit appointment times; view timesheets; view past and upcoming appointments; and match with a plurality of employees or aide users.

The employer may be invited to the application by the care manager. Once invited, the employer can complete their profile and preferences prior to logging in. As will be further discussed below, the employer indicates one or more needs for an employee, which may be reviewed by their care manager who then suggests options for employees in the application based on profile matches. The care manager sets up the care plan for the employer, and the care manager imports the employee and their plan into the application, which the employee receives an email or text message to download the application to set up their own account.

The observer may be invited by the employer. The observer can observe clients belonging to the employer account that invited the user. Observers may oversee, support, and pre-emptively protect employer and clients as they manage a relationship with an aide user. Observers may be permitted to perform any of the following: view available aide users; message aides, observers, and care management users; deactivate account; view schedule appointments; view clock-in and clock-out timestamps in real-time; view geographic information relative to the timestamps; view contacted aids and aide profiles; view timesheets; and view past and upcoming appointments. In some examples, the observer may be designated as an authorized representative on behalf of the employer. For example, the observer may help the employer to make decisions on matching and scheduling services, as will be further discussed below.

The employee creates their own account. The employee seeks employment and may also be referred to as a potential aide or a potential employee. Aide users may be permitted to perform any of the following: request and complete a background check; create and edit their profile; view available client users; gesture to clients; communicate with employers, observers, and care management users; terminate employment relationships; deactivate account; accept job offers; schedule appointments; clock in and clock out of an appointment; edit appointment time; view timesheets; view past and upcoming appointments; and match with a plurality of employers or clients.

The application 115 may be configured to receive profile information. For example, the profile information may include first address information, second address information, one or more needs, one or more services, first availability information, second availability information that are inputted by users into the application 115. In some examples, a background check may be completed prior to inputting the profile information to create a respective profile for a given user. The profile information may be input via the user device 130.

The application 115 may be configured to generate one or more profiles based on the profile information. The one or more profiles may be generated for each of the plurality of users. For example, a profile may be generated for the care manager. A profile may be generated for the employer. A profile may be generated for the observer. A profile may be generated for the employee.

As further explained above, each of the plurality of users may be associated with a predetermined permission level. For example, the profile for the care manager may be associated with a first permission level. The profile for the employer may be associated with a second permission level. The profile for the observer may be associated with a third permission level. The profile for the employee may be associated with a fourth permission level. By way of example, the permission level for the care manager may allow for greater access and actions as compared to the permission level for the employer, observer, and/or employee. The permission level for the employer may allow for greater access and actions as compared to the permission level for the observer. In some examples, the permission level for the observer may be restricted to a scope of only communicating with an aide and/or a care manager, and/or viewing, such as read-only, a portion of the capabilities of the employer. This may be due to the observer having an oversight or support role of the employer, as opposed to acting like the employer capabilities. In other examples, the permission level for the observer may be the same as the permission level of the employer, thereby acting on behalf of the employer.

The application 115 may be configured to identify one or more profile matches based on the one or more profiles. For example, the application 115 may be configured to identify one or more profile matches based on ranking the one or more profile matches according to predetermined criteria. In some examples, the care manager may identify a profile match between a first user, such as an employer, and a second user, such as an aide user. However, it is understood that such designations for the employer and aide user are not limited, and may be interchangeably used, or referred to with any alternative designations. Further, the systems and methods disclosed herein are not limited to first and second users, and any number of users (including a plurality of first users and a plurality of second users) are within the scope of the disclosure. Still further, any number of first users may match profiles with any number of second users. In some examples, a care plan may be preloaded into the application 115. For example, the care plan may be preloaded into the application 115 by the care manager. The care plan may indicate what services are authorized, a number of allowable hours, and an amount of funding that is authorized to purchase the services over a preauthorized period of time.

By way of example, the predetermined criteria includes consideration of proximity of first address information for the first user and second address information for the second user, consideration of overlap between one or more needs for the first user and one or more services for the second user, consideration of overlap between first availability information for the first user and second availability information for the second user, or any combination thereof. In some examples, none of these listed criteria is singularly determinative of identifying one or more profile matches. In other examples, any of these listed criteria is singularly determinative of identifying one or more profile matches.

Regarding the predetermined criteria, and continuing with the above example, the first address information for the first user may include residential address information or non-residential address information, including but not limited to commercial address information of the first user. The second address information for the second user may include residential address information or non-residential address information, including but not limited to commercial address information of the second user. Any of the first address information and the second address information may be included in the profile information. For example, when creating a profile, each of the first and second users may input the respective first address information and second address information into the application 115. In some examples, the first user and/or the second user may be able to see how close their locations are relative to each other based on the first address information and the second address information. For example, based on the first address information and the second address information, the further away the second user is from the first user, the lower the likelihood of identifying a profile match. Based on the first address information and the second address information, the closer the second user is from the first user, the greater the likelihood of identifying a profile match.

Regarding the predetermined criteria, the one or more needs for the first user may include, without limitation, requesting: pet assistance, child assistance, homemaking (including but not limited to vacuuming, dusting, cleaning), grocery shopping and/or meal preparation (such as cooking), laundry, assistance with personal paperwork, personal care (such as bathing and dressing), companion services (activities including but not limited to reading, playing games, and providing time off for a family caregiver), and the like or any combination thereof.

The one or more services for the second user may include, without limitation, providing: pet assistance, child assistance, homemaking (including but not limited to vacuuming, dusting, cleaning), grocery shopping and/or meal preparation (such as cooking), laundry, assistance with personal paperwork, personal care (such as bathing and dressing), companion services (activities including but not limited to reading, playing games, and providing time off for a family caregiver), and the like or any combination thereof. The one or more services for the second user may be responsive to the requested one or more needs by the first user.

Any of one or more needs and the one or more services may be included in the profile information. For example, when creating a profile, each of the first and second users may input the respective one or more needs and one or more services into the application 115.

In some examples, it is understood that the one or more services provided by the second user is not limited to those disclosed herein, and that any other type of home-care service may also be provided by the second user. In other examples, it is understood that the one or more services provided by the second user is limited to those disclosed herein.

Continuing with the above example, a first user may request one or more needs, such as grocery shopping and laundry. A second user may provide grocery shopping, laundry assistance, and personal care whereas a third user may provide personal care and homemaking. Because the one or more services for the second user substantially match or overlap the one or more needs of the first user (here, grocery shopping and laundry assistance), the greater the likelihood of identifying a profile match between the first user and the second user as compared to the likelihood of identifying a profile match between the first user and the third user. Thus, the third user has a lower likelihood of matching its profile with that of the first user.

Regarding the predetermined criteria, the first availability information for the first user may include availability information for when the first user is typically available, including, day, minute, hour, week, month, or the like to request completion of its one or more needs. The second availability information for the second user may include availability information for when the second user is typically available, including day, minute, hour, week, month, or the like to provide the one or more services. Any of the first availability information and the second availability information may be included in the profile information. For example, when creating a profile, each of the first and second users may input the respective first availability information and second availability information into the application 115.

In sum, each of the one or more profiles may be ranked against each other according to the predetermined criteria. In this manner, the matched or substantially matched predetermined criteria, such as the first and second address information, the one or more needs and one or more services, the first and second availability information, may result in a profile match between the first user and the second user. The profile match may or may not be ranked and displayed, listed, or otherwise presented in the application 115. As explained above, it is understood that any number of users, and therefore any number of profile matches, may be identified, ranked, and displayed, listed, or otherwise presented in the application 115.

Without limitation, a second user that has a closer proximity regarding the address information and an overlap in availability regarding the availability information is ranked higher than another user that has only an overlap between the one or more needs and one or more services. However, it is understood that the first user may still select the another user if so desired, and thereby override the predetermined criteria ranking process.

In some examples, the first user may be shown potential second users, or potential aide candidates, who match their needs based on the predetermined criteria, and any other preferences and experience. The first user may browse and review second users profiles, and as will be discussed below, digitally connect with second numbers that they believe would be a good fit. Further, the first user may engage more than one second user to meet their one or more needs based on their individualized care plan and allowable costs.

The application 115 may be configured to generate an appointment to perform one or more tasks based on the one or more profile matches. For example, continuing with the above example, after identifying the one or more profile matches, the application 115 may be configured initiate, between a first user and a second user, a real-time communication session, wherein the first user and the second user communicate with each other in the real-time communication session to generate the appointment.

In some examples, the first user initiates the real-time communication session with the second user in the application 115. The second user is restricted from initiating the real-time communication session in the application 115. The second user signals a gesture to the first user to initiate the real-time communication session. Without limitation, the second user may click a button in the application 115 that is configured to act as a virtual wave gesture as an effort to obtain the attention of the first user so as to initiate the real-time communication session. It is understood that the gesture is not limited to a virtual wave, and that any other type of virtual gestures may be used.

Continuing with the above example, the first user may initiative the real-time communication session in the application 115 with the second user. The first user and the second user may interact with each other in the real-time communication session. For example, the first user and the second user may exchange messages in the real-time communication session without exchanging personal contact information. In this manner, the first user and the second user may come to mutual agreement in the real-time communication session regarding the day and time to perform the one or more services in response to the one or more needs of the first user. It is understood that any number of real-time communication sessions may be generated so as to allow interaction and collaboration between, for example, the second user and the observer, the first user and the observer, the observer and the care manager, the care manager and the first user, and the care manager and the second user.

Accordingly, the first user may communicate with the second user in the real-time communication session to determine whether or not the first user is comfortable with the second user to perform the requested one or more needs, and also whether the second user is a good fit. Thereafter, the first user may send an electronic offer or the electronic agreement to the second user to perform the one or more services in response to the one or more needs of the first user. The second user may accept, counter, or reject the electronic offer or the electronic agreement.

To the extent that an agreement is reached between the first user and the second user, the appointment may be generated to perform one or more tasks based on the one or more profile matches. For example, the one or more tasks may include the one or more services that are based on the one or more profile matches. In some examples, the appointment may be displayed and uploaded into a calendar of the application 115 for all users. The scheduling of the appointment may be generated in real-time and also updated in real-time, depending on any appointment modifications by either or both of the first and the second users. Upon any changes to the originally scheduled appointment, both the first and the second users may be notified of such changes. As explained above, the care manager and the observer are also simultaneously notified of such changes to the originally scheduled appointment.

In some examples, the second user can work with the first user to set appointments for care. These scheduled meetings may be adjusted by time and/or reoccurrence. Further, the appointments may be confirmed and/or edited and/or canceled by the second user or the first user. In some examples, the second user and their care team may add and view notes in real-time to summarize the appointment.

The application 115 may be configured to record, via a built-in digital timer, a clock-in timestamp information and a clock-out timestamp information associated with the appointment to perform the one or more tasks. For example, when the second user is about to begin performance of the one or more services in response to the one or more needs requested by the first user, the second user may be required to click a button in the application 115 that is indicative of a clock-in timestamp information. The clock-in timestamp information includes the day, time, and the like for beginning performance of the one or more tasks. Upon completion of one or all of the one or more tasks, the second user may be required to click a same or different button in the application 115 that is indicative of a clock-out timestamp information. The clock-out timestamp information includes the day, time, and the like for completion of the one or more tasks.

The clock-in timestamp information and clock-out time information may be reviewed to obtain a duration between these pieces of information. Based on the duration and agreed upon rate by the second user, a time sheet may be automatically generated and processed for payment. In some examples, the clock-in timestamp information and the clock-out timestamp information are verified against geolocation information of a device. For example, the device running the application 115, such as the second user device, may be equipped with a receiver configured for use with a Global Navigation Satellite System (GNSS) including, but not limited to, the Global Positioning System (GPS). From this receiver, location information of the device may be extracted and verified against the location of the device at the time of the clock-in timestamp information and the clock-out timestamp information.

Continuing with the above example, after the second user has performed all requested one or more tasks and clocked out at a different location than that location where the one or more tasks were performed, the first and second users, as well as the care manager and the observer, may all be notified. Consequently, the time sheet may be dynamically adjusted to reflect the actual time when the one or more tasks were performed by the second user, instead of the delayed time as clocked out by the second user in the application 115. In some examples, the second user may inadvertently forget to clock-out of the application 115 after performing all requested one or more tasks. Again, the first and second users, as well as the care manager and the observer, may all be notified regarding this error. Consequently, the time sheet may be dynamically adjusted to reflect the actual time when the one or more tasks were performed by the second user, instead of the delayed time as clocked out by the second user in the application 115.

In some examples, the first user may request changes to the time sheet and also approve the time sheet after it has been generated and modified. In some examples, the second user may also be required to approve the time sheet prior to its submission for disbursement. Still further, either of the first or second user may submit requests to the time sheet, which may be approved by the other party or modified by the other prior to its finalization and submission for disbursement.

After an agreed upon time sheet including corresponding time entries, the time sheet may be processed for payment. In some examples, the time sheets may be automatically pulled by an intermediary, including but not limited to a fiscal intermediary, on a predetermined periodic basis (such as every two weeks, monthly, hourly, weekly, daily, or the like). To pull time entries for payroll the intermediary sends a first request to an application API endpoint containing a date range. The application 115 may be configured to respond to the request with a list of approved time entries that fall within the date range and have not been included in any previous pull. After the time entries are processed, the intermediary may send a second request to the application API endpoint, indicating which time entries were processed and also whether each time entry was approved or rejected. This is status is then reflected to users of the application 115.

In some examples, the first user and the second user profile information may be sent to a vendor processing system, such as the Financial Management Services, to decrease paperwork as well as the increase in time it takes to process background checks and set up accounts. The first user and the second user may run the complete timesheet process using the application 115. Based on completion of this information, the vendor may produce payment directly to the second user.

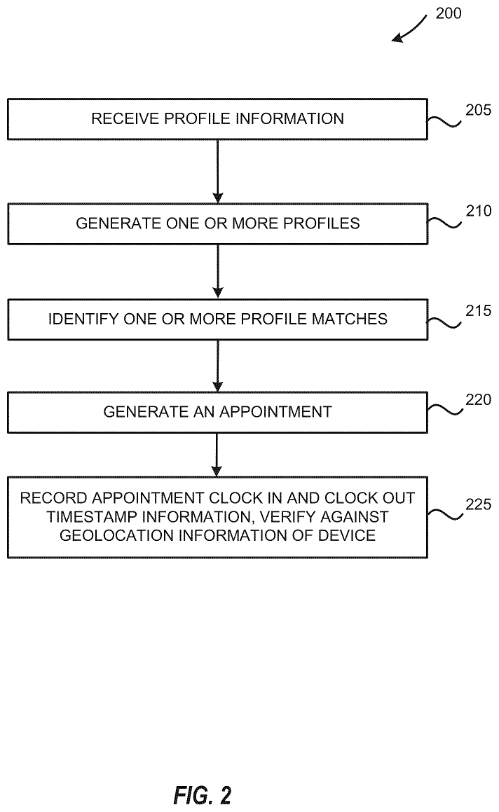

FIG. 2 illustrates a method 200. The method 200 may comprise a computer-implemented method for an application, such as application 115, executing on a device, such as user device 130. The method 200 may reference any of constituent components and functions described above with respect to FIG. 1.

At step 205, the method 200 may include receiving profile information. For example, the profile information may include first address information, second address information, one or more needs, one or more services, first availability information, second availability information that are inputted by users into the application. In some examples, a background check may be completed prior to inputting the profile information to create a respective profile for a given user.

At step 210, the method 200 may include generating one or more profiles based on the profile information. The one or more profiles may be generated for each of the plurality of users. For example, a profile may be generated for the care manager. A profile may be generated for the employer. A profile may be generated for the observer. A profile may be generated for the employee.

As further explained above, each of the plurality of users may be associated with a predetermined permission level. For example, the profile for the care manager may be associated with a first permission level. The profile for the employer may be associated with a second permission level. The profile for the observer may be associated with a third permission level. The profile for the employee may be associated with a fourth permission level. By way of example, the permission level for the care manager may allow for greater access and actions as compared to the permission level for the employer, observer, and/or employee. The permission level for the employer may allow for greater access and actions as compared to the permission level for the observer. In some examples, the permission level for the observer may be restricted to a scope of only communicating with an aide and/or a care manager, and/or viewing a portion of the capabilities of the employer. This may be due to the observer having an oversight or support role of the employer, as opposed to acting like the employer capabilities. In other examples, the permission level for the observer may be the same as the permission level of the employer, thereby acting on behalf of the employer.

At step 215, the method 200 may include identifying one or more profile matches based on the one or more profiles. For example, the method may identify one or more profile matches based on ranking the one or more profile matches according to predetermined criteria. In some examples, the care manager may identify a profile match between a first user, such as an employer, and a second user, such as an aide user. However, it is understood that such designations for the employer and aide user are not limited, and may be interchangeably used, or referred to with any alternative designations. Further, the systems and methods disclosed herein are not limited to first and second users, and any number of users (including a plurality of first users and a plurality of second users) are within the scope of the disclosure. Still further, any number of first users may match profiles with any number of second users.

By way of example, the predetermined criteria includes consideration of proximity of first address information for the first user and second address information for the second user, consideration of overlap between one or more needs for the first user and one or more services for the second user, consideration of overlap between first availability information for the first user and second availability information for the second user, or any combination thereof. In some examples, none of these listed criteria is singularly determinative of identifying one or more profile matches. In other examples, any of these listed criteria is singularly determinative of identifying one or more profile matches.

Regarding the predetermined criteria, and continuing with the above example, the first address information for the first user may include residential address information or non-residential address information, including but not limited to commercial address information of the first user. The second address information for the second user may include residential address information or non-residential address information, including but not limited to commercial address information of the second user. Any of the first address information and the second address information may be included in the profile information. For example, when creating a profile, each of the first and second users may input the respective first address information and second address information into the application. In some examples, the first user and/or the second user may be able to see how close their locations are relative to each other based on the first address information and the second address information. For example, based on the first address information and the second address information, the further away the second user is from the first user, the lower the likelihood of identifying a profile match. Based on the first address information and the second address information, the closer the second user is from the first user, the greater the likelihood of identifying a profile match.

Regarding the predetermined criteria, the one or more needs for the first user may include, without limitation, requesting: pet assistance, child assistance, homemaking (including but not limited to vacuuming, dusting, cleaning), grocery shopping and/or meal preparation (such as cooking), laundry, assistance with personal paperwork, personal care (such as bathing and dressing), companion services (activities including but not limited to reading, playing games, and providing time off for a family caregiver), and the like or any combination thereof.

The one or more services for the second user may include, without limitation, providing: pet assistance, child assistance, homemaking (including but not limited to vacuuming, dusting, cleaning), grocery shopping and/or meal preparation (such as cooking), laundry, assistance with personal paperwork, personal care (such as bathing and dressing), companion services (activities including but not limited to reading, playing games, and providing time off for a family caregiver), and the like or any combination thereof. The one or more services for the second user may be responsive to the requested one or more needs by the first user.

Any of one or more needs and the one or more services may be included in the profile information. For example, when creating a profile, each of the first and second users may input the respective one or more needs and one or more services into the application.

In some examples, it is understood that the one or more services provided by the second user is not limited to those disclosed herein, and that any other type of home-care service may also be provided by the second user. In other examples, it is understood that the one or more services provided by the second user is limited to those disclosed herein.

Continuing with the above example, a first user may request one or more needs, such as grocery shopping and laundry. A second user may provide grocery shopping, laundry assistance, and personal care whereas a third user may provide personal care and homemaking. Because the one or more services for the second user substantially match or overlap the one or more needs of the first user (here, grocery shopping and laundry assistance), the greater the likelihood of identifying a profile match between the first user and the second user as compared to the likelihood of identifying a profile match between the first user and the third user. Thus, the third user has a lower likelihood of matching its profile with that of the first user.

Regarding the predetermined criteria, the first availability information for the first user may include availability information for when the first user is typically available, including, day, minute, hour, week, month, or the like to request completion of its one or more needs. The second availability information for the second user may include availability information for when the second user is typically available, including day, minute, hour, week, month, or the like to provide the one or more services. Any of the first availability information and the second availability information may be included in the profile information. For example, when creating a profile, each of the first and second users may input the respective first availability information and second availability information into the application.

In sum, each of the one or more profiles may be ranked against each other according to the predetermined criteria. In this manner, the matched or substantially matched predetermined criteria, such as the first and second address information, the one or more needs and one or more services, the first and second availability information, may result in a profile match between the first user and the second user. The profile match may or may not be ranked and displayed, listed, or otherwise presented in the application. As explained above, it is understood that any number of users, and therefore any number of profile matches, may be identified, ranked, and displayed, listed, or otherwise presented in the application.

Without limitation, a second user that has a closer proximity regarding the address information and an overlap in availability regarding the availability information is ranked higher than another user that has only an overlap between the one or more needs and one or more services. However, it is understood that the first user may still select the another user if so desired, and thereby override the predetermined criteria ranking process.

In some examples, the first user may be shown potential second users, or potential aide candidates, who match their needs based on the predetermined criteria, and any other preferences and experience. The first user may browse and review second users profiles, and as will be discussed below, digitally connect with second numbers that they believe would be a good fit. Further, the first user may engage more than one second user to meet their one or more needs based on their individualized care plan and allowable costs.

At step 220, the method 200 may include generating an appointment to perform one or more tasks based on the one or more profile matches. For example, continuing with the above example, after identifying the one or more profile matches, the method may include initiating, between a first user and a second user, a real-time communication session, wherein the first user and the second user communicate with each other in the real-time communication session to generate the appointment.

In some examples, the first user initiates the real-time communication session with the second user in the application. The second user is restricted from initiating the real-time communication session in the application. The second user signals a gesture to the first user to initiate the real-time communication session. Without limitation, the second user may click a button in the application that is configured to act as a virtual wave gesture as an effort to obtain the attention of the first user so as to initiate the real-time communication session. It is understood that the gesture is not limited to a virtual wave, and that any other type of virtual gestures may be used.

Continuing with the above example, the first user may initiative the real-time communication session in the application with the second user. The first user and the second user may interact with each other in the real-time communication session. For example, the first user and the second user may exchange messages in the real-time communication session without exchanging personal contact information. In this manner, the first user and the second user may come to mutual agreement in the real-time communication session regarding the day and time to perform the one or more services in response to the one or more needs of the first user. It is understood that any number of real-time communication sessions may be generated so as to allow interaction and collaboration between, for example, the second user and the observer, the first user and the observer, the observer and the care manager, the care manager and the first user, and the care manager and the second user.

Accordingly, the first user may communicate with the second user in the real-time communication session to determine whether or not the first user is comfortable with the second user to perform the requested one or more needs, and also whether the second user is a good fit. Thereafter, the first user may send an electronic offer or the electronic agreement to the second user to perform the one or more services in response to the one or more needs of the first user. The second user may accept, counter, or reject the electronic offer or the electronic agreement.

To the extent that an agreement is reached between the first user and the second user, the appointment may be generated to perform one or more tasks based on the one or more profile matches. For example, the one or more tasks may include the one or more services that are based on the one or more profile matches. In some examples, the appointment may be displayed and uploaded into a calendar of the application for all users. The scheduling of the appointment may be generated in real-time and also updated in real-time, depending on any appointment modifications by either or both of the first and the second users. Upon any changes to the originally scheduled appointment, both the first and the second users may be notified of such changes. As explained above, the care manager and the observer are also simultaneously notified of such changes to the originally scheduled appointment.

In some examples, the second user can work with the first user to set appointments for care. These scheduled meetings may be adjusted by time and/or reoccurrence. Further, the appointments may be confirmed and/or edited and/or canceled by the second user or the first user. In some examples, the second user and their care team may add and view notes in real-time to summarize the appointment.

At step 225, the method 200 may include recording a clock-in timestamp information and a clock-out timestamp information associated with the appointment to perform the one or more tasks. For example, when the second user is about to begin performance of the one or more services in response to the one or more needs requested by the first user, the second user may be required to click a button in the application that is indicative of a clock-in timestamp information. The clock-in timestamp information includes the day, time, and the like for beginning performance of the one or more tasks. Upon completion of one or all of the one or more tasks, the second user may be required to click a same or different button in the application that is indicative of a clock-out timestamp information. The clock-out timestamp information includes the day, time, and the like for completion of the one or more tasks.

The clock-in timestamp information and clock-out time information may be reviewed to obtain a duration between these pieces of information. Based on the duration and agreed upon rate by the second user, a time sheet may be automatically generated and processed for payment. In some examples, the clock-in timestamp information and the clock-out timestamp information are verified against geolocation information of a device. For example, the device running the application, such as the second user device, may be equipped with a receiver configured for use with a Global Navigation Satellite System (GNSS) including, but not limited to, the Global Positioning System (GPS). From this receiver, location information of the device may be extracted and verified against the location of the device at the time of the clock-in timestamp information and the clock-out timestamp information.

Continuing with the above example, after the second user has performed all requested one or more tasks and clocked out at a different location than that location where the one or more tasks were performed, the first and second users, as well as the care manager and the observer, may all be notified. Consequently, the time sheet may be dynamically adjusted to reflect the actual time when the one or more tasks were performed by the second user, instead of the delayed time as clocked out by the second user in the application. In some examples, the second user may inadvertently forget to clock out of the application after performing all requested one or more tasks. Again, the first and second users, as well as the care manager and the observer, may all be notified regarding this error. Consequently, the time sheet may be dynamically adjusted to reflect the actual time when the one or more tasks were performed by the second user, instead of the delayed time as clocked out by the second user in the application.

In some examples, the first user may request changes to the time sheet and also approve the time sheet after it has been generated and modified. In some examples, the second user may also be required to approve the time sheet prior to its submission for disbursement. Still further, either of the first or second user may submit requests to the time sheet, which may be approved by the other party or modified by the other prior to its finalization and submission for disbursement.

After an agreed upon time sheet including corresponding time entries, the time sheet may be processed for payment. In some examples, the time sheets may be automatically pulled by an intermediary, including but not limited to a fiscal intermediary, on a predetermined periodic basis (such as every two weeks, monthly, hourly, weekly, daily, or the like). To pull time entries for payroll the intermediary sends a first request to an application API endpoint containing a date range. The application may be configured to respond to the request with a list of approved time entries that fall within the date range and have not been included in any previous pull. After the time entries are processed, the intermediary may send a second request to the application API endpoint, indicating which time entries were processed and also whether each time entry was approved or rejected. This is status is then reflected to users of the application.

In some examples, the first user and the second user profile information may be sent to a vendor, such as the Financial Management Services, to decrease paperwork as well as the increase in time it takes to process background checks and set up accounts. The first user and the second user may run the complete timesheet process using the application. Based on completion of this information, the vendor may produce payment directly to the second user.

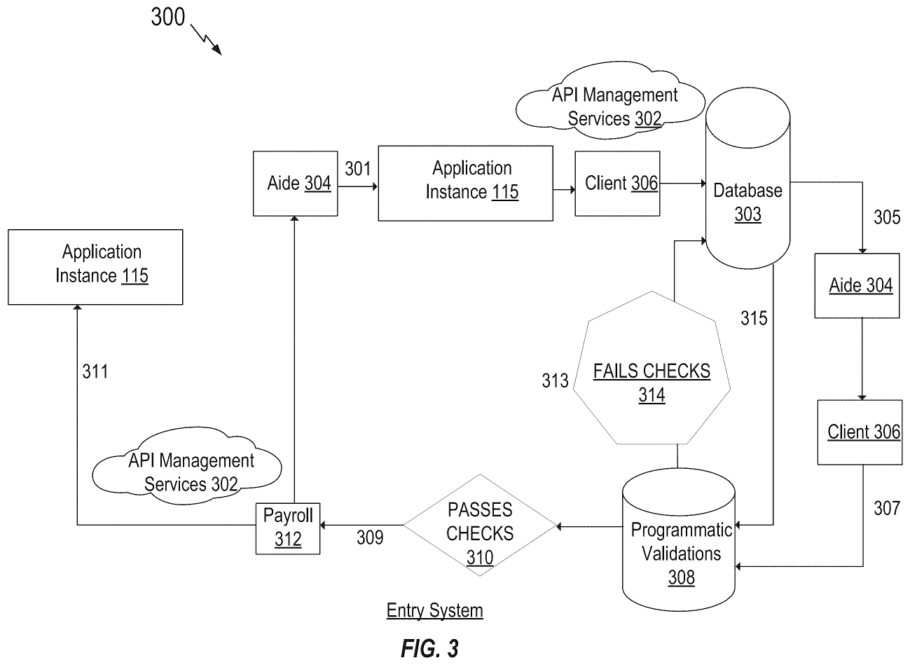

FIG. 3 illustrates an entry system 300. FIG. 3 may reference and incorporate any of the disclosure depicted and described above with respect to FIGS. 1-2.

The entry system 300 may be configured to process time entries for payroll processing. At 301, an aide 304 of a user device 130 may input clock-in and clock-out timestamp information in the application instance 115. As previously discussed above, the clock-in and clock-out timestamp information may be verified against geolocation information of the user device 130. A client 306 of a user device 130, same or different than the user device of the aide 304, may review and approve the timestamp information in the application instance 115. The approved shifts may be exported via an API to a database 303, such as Palco Connect®. In some examples, the client 306 of the user device 130 may submit the time in the application instance 115 to the database 303 via API management services 302. At 315, the database 303 may submit the pending timesheet status, locked for review, to database 308. The database 308 may be configured to perform programmatic validations and budget checks. In some examples, the database 308 may be a different or same database as database 303.

At 310, the database 308 may be configured to approve the timesheet status for payment and at 309 may submit it to payroll 312, such as a payroll system, for payment. At 311, the paid timesheet status may be pushed back to the application instance 115, via the API management services 302, for display within the application instance 115. To the extent that the timesheet status fails checks at 314, such as due to being over budget, the timesheet status is updated to indicate that a resolution is needed before further processing. At 313, the resolution request is submitted back to database 303 for resolving the failed check. At 305, the aide 304 of the user device 130 may correct the timesheet in the application instance 115 and submits it to the client 306 of the user device 130. In response, the client 306 of the user device 130 may, within the application instance 115, review and submit the corrected timesheet to the database 308. Alternatively, the client 306 of the user device 130 may, within the application instance 115, reject the corrected timesheet and send it back to the aide 304 of the user device 130 with additional corrections, and then the process may repeat until the aide 304 and employer or client 306 arrive at mutual agreement regarding the timesheet.

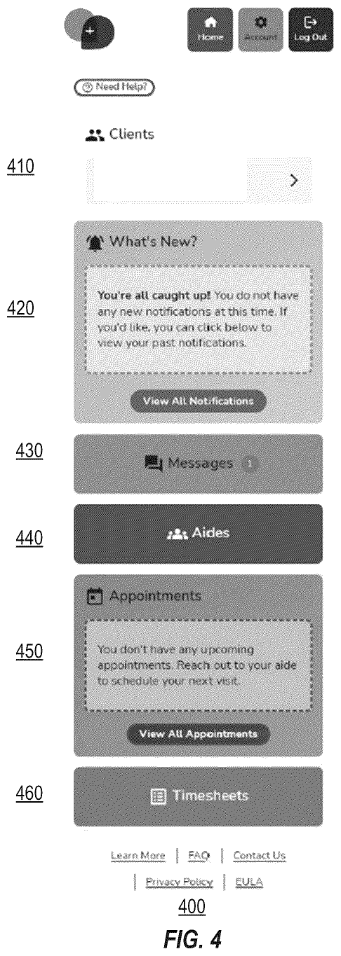

FIG. 4 illustrates a user interface 400 in the application 115. FIG. 4 may reference and incorporate any of the disclosure depicted and described above with respect to FIGS. 1-3.

The user interface 400 in the application 115 includes clients 410, a notification portion 420, messages 430, aides 440, appointments 450, and timesheets 460. For example, the clients 410 may include any of the clients users that have been created. In some examples, the first and last name of the client may be displayed. The notification portion 420 may include a button to view all notifications, including past and present notifications. When a notification, including but not limited to a message or an appointment change or a profile match been performed or provided, the notification portion 420 may signal, via a bell icon, of the corresponding notification. The messages 430 may include a button to view messages in the real-time communication session. For example, the messages 430 may display a number of messages that are unread, such as in a colored circle including the number of unread messages. The aides 440 may include a button upon to view any of the aides. The appointments 450 may include a button to view all appointments, including past and upcoming appointments. When an appointment has been generated, it can show up in the appointments 450. The timesheets 460 may include a button to view timesheets, either that been edited or finalized.

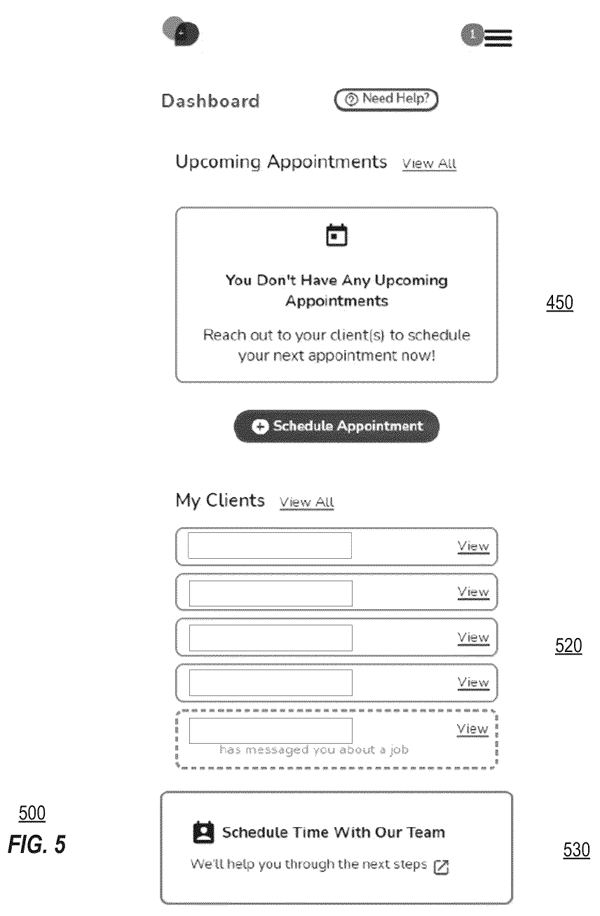

FIG. 5 illustrates a user interface 500 in the application 115. FIG. 5 may reference and incorporate any of the disclosure depicted and described above with respect to FIGS. 1-4.

The user interface 500 in the application 115 includes appointments 450. The appointments 450 may include a button to view all appointments, including past and upcoming appointments. When an appointment has been generated, it can show up in the appointments 450. The user interface 500 includes my clients 520. The my clients 520 may include a button to view each of the clients of a given aide, as well as an indication if any of the clients have messaged the aide in the real-time communication session. The user interface 500 includes scheduling appointments 530. The appointments may be generated and scheduled as previously disclosed above.

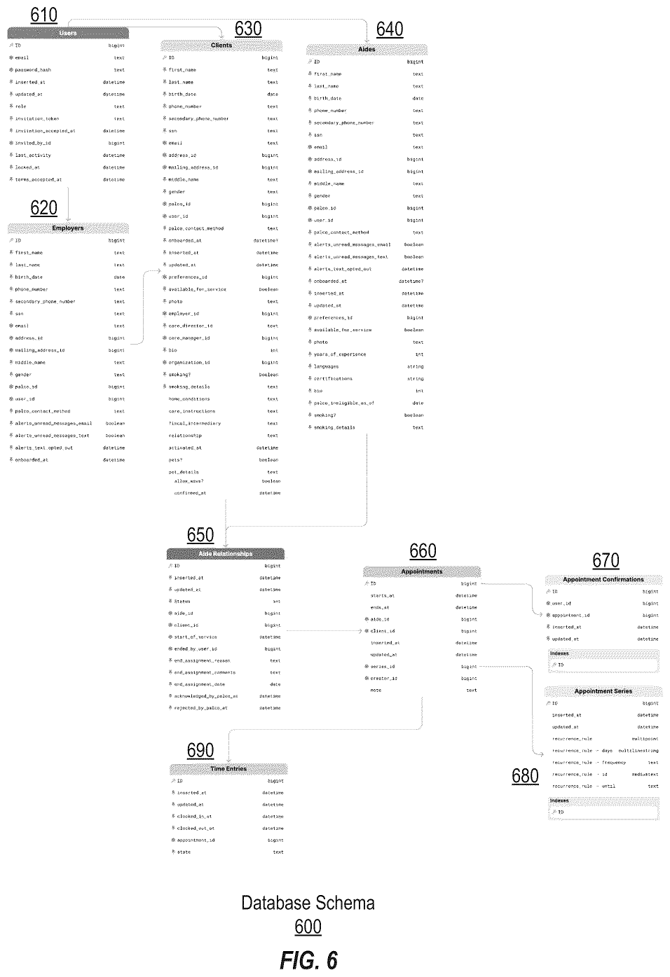

FIG. 6 illustrates database schema 600, such that are stored and retrieved in database 110 for processing by application 115, for users 610, employers 620, clients 630, and aides 640. FIG. 6 also depicts various aide relationships 650, appointments 660, appointment confirmations 670, appointment series 680, and time entries 690. FIG. 6 may reference and incorporate any of the disclosure depicted and described above with respect to FIGS. 1-5.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
receiving profile information;
generating one or more profiles based on the profile information;
identifying one or more profile matches based on the one or more profiles;
generating an appointment to perform one or more tasks based on the one or more profile matches; and
recording a clock-in timestamp information and a clock-out timestamp information associated with the appointment to perform the one or more tasks, wherein the clock-in timestamp information and the clock-out timestamp information are verified against geolocation information of a device.

2. The method of claim 1, further comprising initiating, between a first user and a second user, a real-time communication session, wherein the first user and the second user communicate with each other in the real-time communication session to generate the appointment.

3. The method of claim 2, wherein the first user initiates the real-time communication session with the second user.

4. The method of claim 2, wherein the second user is restricted from initiating the real-time communication session.

5. The method of claim 2, wherein the second user signals a gesture to the first user to initiate the real-time communication session.

6. The method of claim 1, further comprising ranking the one or more profile matches according to predetermined criteria.

7. The method of claim 6, wherein the predetermined criteria includes consideration of proximity of first address information for a first user and second address information for a second user, consideration of overlap between one or more needs for the first user and one or more services for the second user, consideration of overlap between first availability information for the first user and second availability information for the second user, or any combination thereof.

8. An application system comprising:
one or more processors; and
one or more memories, wherein the one or more processors are configured to:
receive profile information;
generate one or more profiles based on the profile information;
identify one or more profile matches based on the one or more profiles;
generate an appointment to perform one or more tasks based on the one or more profile matches; and
record a clock-in timestamp information and a clock-out timestamp information associated with the appointment to perform the one or more tasks, wherein the clock-in timestamp information and the clock-out timestamp information are verified against geolocation information of a device.

9. The application system of claim 8, wherein the one or more processors are further configured to initiate, between a first user and a second user, a real-time communication session, wherein the first user and the second user communicate with each other in the real-time communication session to generate the appointment.

10. The application system of claim 9, wherein the first user initiates the real-time communication session with the second user.

11. The application system of claim 9, wherein the second user is restricted from initiating the real-time communication session.

12. The application system of claim 9, wherein the second user signals a gesture to the first user to initiate the real-time communication session.

13. The application system of claim 8, wherein the one or more processors are further configured to rank the one or more profile matches according to predetermined criteria.

14. The application system of claim 13, wherein the predetermined criteria includes consideration of proximity of first address information for a first user and second address information for a second user, consideration of overlap between one or more needs for the first user and one or more services for the second user, consideration of overlap between first availability information for the first user and second availability information for the second user, or any combination thereof.

15. A non-transitory computer-readable medium comprising instructions that, when executed by at least one processor, cause the at least one processor to perform operations comprising:
receiving profile information;
generating one or more profiles based on the profile information;
identifying one or more profile matches based on the one or more profiles;
generating an appointment to perform one or more tasks based on the one or more profile matches; and
recording a clock-in timestamp information and a clock-out timestamp information associated with the appointment to perform the one or more tasks, wherein the clock-in timestamp information and the clock-out timestamp information are verified against geolocation information of a device.

16. The non-transitory computer-readable medium of claim 15, further comprising initiating, between a first user and a second user, a real-time communication session, wherein the first user and the second user communicate with each other in the real-time communication session to generate the appointment.

17. The non-transitory computer-readable medium of claim 16, wherein the first user initiates the real-time communication session with the second user.

18. The non-transitory computer-readable medium of claim 16, wherein the second user is restricted from initiating the real-time communication session.

19. The non-transitory computer-readable medium of claim 16, wherein the second user signals a gesture to the first user to initiate the real-time communication session.

20. The non-transitory computer-readable medium of claim 15, further comprising ranking the one or more profile matches according to predetermined criteria, the predetermined criteria including consideration of proximity of first address information for a first user and second address information for a second user, consideration of overlap between one or more needs for the first user and one or more services for the second user, consideration of overlap between first availability information for the first user and second availability information for the second user, or any combination thereof.
